(19) United States
(12) Patent Application Publication
(10) Pub. No.: US 2026/0200123 A1
(43) Pub. Date: Jul. 16, 2026

(54) METHOD FOR CONNECTING WOODEN STRUCTURAL PANELS

(71) Applicant: Timber Structures 3.0 AG, Thun (CH)

(72) Inventor: Stefan Zöllig, Thun (CH)

(73) Assignee: Timber Structures 3.0 AG, Thun (CH)

(21) Appl. No.: 19/121,896

(22) PCT Filed: Oct. 4, 2023
(86) PCT No.: PCT/IB2023/059960

§ 371 Date: Apr. 17, 2025

(30) Foreign Application Priority Data
Oct. 18, 2022 (CH) CH001228/2022

(51) Int. Cl. B27D 1/10; B27M 3/00

(52) U.S. Cl. CPC B27D 1/10; B27M 3/0053; B27M 3/0086

(57) ABSTRACT

A method of manufacturing a composite timber construction panel for building structures. The method includes arranging (201) a first timber construction panel (10) with respect to a second timber construction panel. The first timber construction panel (10) has one or more recesses (4.1, 4.2, 4.n) in a first lateral side (1), the recesses having a flat floor extending over a portion of the area of the first lateral side (1), wherein the floors of the one or more recesses (4.1, 4.2, 4.n) together occupy at least 50% of the first lateral side (1) of the first timber construction panel (10), and wherein the recesses (4.1, 4.2, 4.n) are laterally at least partially delimited by portions (13) of the first timber construction panel, such that one or more of the delimiting portions (13) of the one or more recesses (4.1, 4.2, 4.n) of the first timber construction panel adjoin a first lateral side of the second timber construction panel (20), filling (203) of the one or more recesses (4.1, 4.2, 4.n) with a two-component adhesive, and curing (204) of the two-component adhesive. A composite timber construction panel includes two timber construction panels (10, 20) which are bonded together via the above-mentioned cavities (3).

### TECHNICAL AREA

The invention relates to large-area, load-bearing timber construction panels for the construction industry, as well as to a manufacturing method for large-area timber construction panels.

### STATE OF THE ART

Due to its sustainability and durability, wood is an increasingly attractive building material in the construction industry. However, the specific characteristics of this natural raw material pose technical challenges for timber construction, as concrete and steel cis used and processed in a different way than timber.

A particular challenge is the production of large-area, load-bearing timber construction panels, which are used in storey ceilings, for example. In conventional buildings, concrete is poured in liquid form on site in order to produce the panels or ceilings directly in the building.

Construction panels used in timber construction are predominantly biaxially load-bearing in order to be able to withstand the load forces acting on the panels in the building. Timber construction panels made of biaxial load-bearing timber materials are particularly suitable for use in construction.

Timber material is usually processed into panels in an industrial production facility before being assembled on site into a sufficiently large, flat timber component, such as a ceiling.

WO2014173633 describes a method in which timber construction elements are assembled into load-bearing components for timber construction by gluing them together over a gap. The method makes it possible to assemble individual panels to form entire storey ceilings on site.

Bonding the panels on site is done manually and thus involves a considerable amount of labor and time.

In order to minimize the number of panels to be bonded on site and thus improve the efficiency of the construction of the storey ceilings on site, it is desirable to join panels that are as large as possible and that are dimensioned in such a way that they can be transported to the construction site by conventional trucks. Joining larger panels on site is quicker as there are fewer joints to be made between the individual panels. The amount of work involved in arranging the individual panels and gluing them together is reduced if smaller panels are replaced by a smaller number of larger panels.

However, the spatial dimensions of the timber construction panels that are produced industrially today are limited for process engineering and logistical reasons. As a result, construction sites are supplied with a large number of relatively small panels, which are then joined together on site to form a large component. However, for the reasons mentioned above, this not only impairs the efficiency of completing a large-area component from a large number of relatively small panels, but also increases the time and effort involved in loading and unloading a transport vehicle.

It is therefore desirable to manufacture the largest possible timber construction panels at the production site, and to dimension the timber construction panels in such a way that they can be transported by conventional trucks.

### Short Description of the Invention

It is an aim of the present invention to find a method that enables the production of large-area timber construction panels in the production facility.

It is a further aim of the present invention to render the manufacture of timber-based storey ceilings more efficient. The manufacturing method should preferably be associated with a reduced amount of time and/or labor on the construction site.

It is a further aim of the present invention to provide an alternative manufacturing method for known methods of producing large-area timber construction panels.

It is an additional aim of the present invention to find a large-area timber construction panel which is robust and durable. The large-area timber construction panel should be equipped to form a load-bearing component of a storey ceiling of a building.

According to the invention, one or more of these aims are attained by a method for producing a composite timber construction panel for building structures, and/or by a composite timber construction panel according to the independent claims. Further advantageous embodiments of the method and of the composite timber construction panel are provided in the dependent claims.

The term “timber construction panel” as used herein means a structural element made of a timber-based material with two mutually parallel usable surfaces, which can form a top side and a bottom side depending on the orientation, and lateral sides, each of which has smaller dimensions than a usable surface. The two usable surfaces have the same dimensions.

The plates can take the form of a flat parallelepiped. The usable surfaces can take the form of a rectangular quadrilateral, for example a square. The timber panels are preferably cuboids. In the embodiments mentioned in this paragraph, the panel has two usable surfaces and four lateral sides.

However, the panels can also have triangular usable surfaces or other polygonal usable surfaces. The number of lateral faces varies accordingly with the shape of the base surface.

The term “timber-based material” as used herein means a material that is produced from joined, shredded wood, for example by gluing. Timber-based materials are, for example, cross-laminated timber, cross-laminated timber, veneer plywood or glulam. Cross-laminated timber, also known as “CLT”, also includes cross-ply timber. Timber-based materials in which the chopped timber structural elements are arranged crosswise may be biaxially load-bearing.

Specifically, one or more of the above aims are attained by a method of making composite timber construction panels in which a first timber construction panel having one or more recesses in a first lateral side is arranged with respect to a second timber construction panel having a first lateral side such that the two first lateral sides of the timber construction panels are contiguous.

Optionally, the method also comprises a step of forming the recesses in the first lateral side of the first timber construction panel.

Each of the one or more recesses in the first lateral side of the first timber construction panel is formed such that it expands over a portion of the first lateral side. Preferably, the one or more recesses have a flat floor.

The one or more recesses preferably have a minimum depth of 1 mm, 2 mm, 3 mm, 4 mm or 5 mm. Each recess preferably has a uniform depth. This means that the depth of each recess is substantially constant over its delimiting bottom surface, such that the floor of the recess is flat.

“Essentially constant” means that the floor is flat, but may exhibit a material-related unevenness and therefore the depth may vary due to this material-related unevenness. A flat floor may therefore comprise a material-related unevenness. A flat floor is free of artificially incorporated structural elements.

In order to improve the durability of the surface bonding of the timber construction panels, the recesses should preferably together occupy at least 50%, at least 60%, at least 70%, at least 80%, at least 90%, at least 95%, or at least 98% of the first lateral side. The recesses should not occupy more than 99% of the first lateral side.

The recesses are preferably produced in an automated process step.

The portions of the first lateral side that are not recessed surround the one or more recesses to at least partially delimit them. The portions of the first lateral side that are not recessed are preferably arranged such that the two lateral edges, as well as the lower edge along one of the base surfaces, continue to be maintained. These portions may for example be formed as ridges of the first timber construction panel.

The first timber construction panel with the at least one recess is arranged relative to a second timber construction panel in such a way that the portions delimiting the at least one recess of the first lateral side of the first timber construction panel adjoin a first lateral side of a second timber construction panel.

The two timber panels are preferably joined together in such a way that their connecting surfaces are not displaced against each other. The two joined timber panels are therefore fixed in position in relation to each other.

The connecting surfaces of the first lateral sides of the timber construction panels are preferably parallel to the flat base of the first side of the first timber construction panel. Accordingly, the connecting surfaces of the respective first sides of the two timber construction panels do not interlock.

Preferably, neither of the first lateral sides has a structural element, such as a protrusion, extending into a depression or recess of the first side of the respective other timber construction panel. Preferably, the structural element of each of the two timber construction panels that is closest to the first lateral side of the other timber construction panel is the connecting surface of the first lateral side of each of the two timber construction panels.

The dimensions of the two timber construction panels may be identical or essentially identical.

The first and second timber panels are preferably biaxially load-bearing panels made of timber-based material. A biaxially load-bearing timber-based panel is a component made of timber-based material that is load-bearing over its entire surface.

If the two timber construction panels each have two lateral long sides and two shorter lateral broad sides the two construction panels are preferably joined to one another such that a lateral long side is joined with a corresponding lateral long side, or such that a lateral broad side is joined with a corresponding lateral broad side.

This arrangement of the two timber construction panels relative to one another forms one or more cavities, which are delimited by the base of the at least one recess, the portions of the timber construction panel delimiting the recess, and the first lateral side of the second timber construction panel.

The two timber construction panels may be arranged in relation to each other by machine in an automated process.

The joints of the connecting surfaces are preferably sealed on at least three outer sides. Optionally, the two lateral edges and the lower edge of the adjoining first lateral sides of the first and second timber construction panel are sealed.

Sealing may be achieved by applying a sealing compound, for example an adhesive or silicone, to the connecting surfaces of the delimiting portions of the first timber construction panel before the step of arranging the two timber construction panels. By joining the two timber construction panels together as described above, the connecting surfaces of the two timber construction panels are sealed by the sealing compound.

Sealing can also be carried out after the two timber construction panels have been arranged in relation to each other and before the at least one cavity is filled with adhesive.

It is also possible for a sealing compound to be applied to the delimiting portions of the first timber construction panel before arrangement and then additionally sealed after arrangement, for example by applying a sealing compound along at least part of the edges of the joined surfaces.

The sealing of the adjoining portions of the first and second timber construction panels may be automated.

The cavities formed by the recesses created by the joined timber panels can then be filled with a two-component adhesive. To ensure the stability of the bond, the cavities should be completely filled with adhesive. The formation of air bubbles should be avoided.

The cavities are preferably filled automatically in a production facility. However, filling can also be carried out manually, for example on a construction site.

For the stability of the joint, it is important that the adhesive fills a minimum distance between the bonded surfaces of the two timber panels. This minimum distance is at least 1 mm, 2 mm, 3 mm, 4 mm or 5 mm and is determined by the recesses or at least one cavity. The distance between the bonded surfaces may for example be 20 mm or less. However, larger distances between the bonded surfaces are also suitable for forming a load-bearing connection between the two timber panels.

A minimum distance of 3 mm has the advantage that the inclusion of air bubbles can be better avoided. At distances of less than 3 mm, air bubbles can very easily get trapped when injecting a two-component adhesive into the joint.

The minimum distance between the bonded surfaces is crucial for the stability of the bond. The cured two-component adhesive layer located at the distance can transfer a load force that is introduced into one of the two panels across this distance in the bonded panel. However, if the distance is too small, the force transmission between the bonded panels is reduced. Up to 20 mm, the ability to transfer force increases with the distance between the bonded surfaces.

The joint strength tends to increase with increasing thickness of the adhesive layer. As mentioned, air entrapment can be largely avoided in joints of 3 mm and larger, which contributes to the improved quality of the bonded joint.

The injected two-component adhesive is then let to harden without exerting any compression pressure in the at least one cavity, so that a robust connection is created between the two timber construction panels. It is important that the two-component adhesive filled into the at least one cavity is not compressed during curing, as compressing the adhesive during curing can impair the ability of the adhesive layer to transfer force.

The first lateral side of the second timber construction panel may also have one or more recesses. Preferably, these recesses correspond to the recesses of the first timber construction panel in their arrangement, so that the surfaces of the respective portions of the first and the second timber construction panels, which delimit the respective recesses, adjoin one another in the timber construction panels arranged as described above. In the arranged timber construction panels, a recess of the first timber construction panel and a corresponding recess of the second timber construction panel jointly form a cavity. This design has the advantage that the cavity is distributed over both panels. The recesses in the first lateral sides of the two timber construction panels can therefore each have a shallow depth in order to nevertheless achieve stable bonding of the two panels over a predetermined minimum distance.

However, the first lateral side of the second timber panel can also be uniformly flat. This has the advantage that the recesses in the first timber panel do not have to correspond to the arrangement of recesses in the first lateral side of the second timber panel. The arrangement of the at least one recess in the first lateral side of the first timber panel can therefore be less precise. From a procedural point of view, this embodiment is less complex and therefore preferred.

If at least one cavity is sealed on three sides, it may be filled with adhesive from above. However, air bubbles can very easily get trapped during filling from above, which reduces the quality of the bond.

To prevent this, at least one cavity should be filled from below or through a filling opening in its lower area. A transverse filling opening that extends from the upper usable surface of one of the two panels into the lower area of a cavity is very suitable for this purpose. The filling opening may be a drilled opening, for example.

A two-component polyurethane is particularly suitable for forming a force-transmitting adhesive layer. A two-component polyurethane is also very suited for pouring into the cavities.

In one possible embodiment, the cavity or cavities are surrounded on all lateral sides by delimiting portions of the first timber construction panel, or by delimiting portions of the first and second timber structural panels. In other words, the cavity or cavities between the first and second timber construction panels are fully encompassed by delimiting portions of the first timber construction panel and, optionally, by delimiting portions of the second timber construction panel. However, the term “entirely” does not exclude the presence of a vent opening in one of the delimiting portions that opens into a cavity.

Enclosing the cavity or cavities from all sides prevents dirt from penetrating into the cavity or into the adhesive layer. Contamination can weaken the adhesive layer and therefore the bond between the panels. Furthermore, a closed design of the cavity or cavities prevents the adhesive layer from being exposed to adverse chemical or mechanical environmental influences, such as cleaning agents or brushes, via an open joint. The adhesive layer in the closed cavity is thus protected from the outside world. This contributes to the durability of the bonding of the timber construction panels.

In the closed version, the usable surfaces of the two timber panels are preferably flush with each other. This not only contributes to the above-mentioned advantages of the closed cavity, but is also visually advantageous, as it creates a uniform appearance of the composite, large-area panel.

In this closed design, however, the air in the cavity is prevented from escaping during filling. For this reason, one or more vent openings must be provided in this design, which are arranged to allow the air in the cavity to escape. The vent opening can, for example, be a drilled opening leading into the cavity.

Some or all of the process steps described herein are preferably carried out in an industrial production plant. The process is suitable for complete automation and therefore enables the production of composite panels on an industrial scale. The timber construction panels produced are therefore larger and not limited to the dimensions of industrially produced individual panels.

The invention also relates to a composite timber construction panel which is produced according to the method described herein.

The composite timber panel comprises a first timber panel having one or more recesses extending over a portion of a first lateral surface, and a second timber panel having a first lateral surface contiguous with the first lateral surface of the first timber panel.

The first and second timber panels together form one or more cavities caused by the recesses. The distance between the floor of the at least one recess of the first timber construction panel delimiting the cavity and the surface of the second timber construction panel delimiting the cavity is at least 1 mm, at least 2 mm, at least 3 mm, at least 4 mm, or at least 5 mm. The cavity is completely filled with a two-component adhesive, for example with a two-component polyurethane.

At least one of the two usable surfaces of the first timber construction panel adjoins at least one of the two usable surfaces of the second timber construction panel in the composite timber construction panel of the present invention. In a preferred embodiment, each of the two usable surfaces of the first timber construction panel adjoin the corresponding usable surfaces of the second timber construction panel.

One or both of the usable surfaces of the first and second timber panels are preferably flush with each other. However, it is also possible for a sealing material, such as silicone, to be visibly embedded between the adjoining edges of the usable surfaces.

The composite timber construction panel preferably has a composite usable area of 1 m² to 50 m², or from 10 m² to 34 m². The timber construction panels, as well as the resulting composite timber construction panel, may have a layer thickness of 6 cm to 40 cm, preferably from 10 cm to 32 cm. The composite timber panels may have a composite length of 1 m to 15 m, or 1 m to 13.5 m. The composite timber panels may have a composite width of 0.5 m to 2.5 m, or from 0-5 m to 3.5 m.

The length and width of the assembled timber construction panels may be adapted to the dimensions specified by the conventional means of transportation.

Timber panels of these dimensions can be easily transported using conventional means of transport. For example, European conventional semi-trailers have a maximum overall length of 16.5 meters. The length of the semi-trailer is about 13.6 m, its width about 2.5 m.

Preferably, the method described herein is carried out at a first location, for example at a production plant. The assembled timber construction panels according to this method can then be transported to a second location where the assembled panel is used. This second location is, for example, a construction site or in an existing building in which the composite timber construction panel is installed. The composite timber construction panel is preferably transported to its place of use by a conventional means of transport, for example by a freight train and/or a conventional truck.

### SHORT DESCRIPTION OF THE FIGURES

The invention is explained in more detail with reference to the attached figures, which show

FIGS. 1a to 1e, as well as 2a and 2b are illustrations of possible embodiments of a composite timber construction panel in which the upper and lower usable surfaces of the two bonded panels are flush with each other.

FIG. 1a is a top view of the assembled timber construction panel, two recesses hidden by the usable surface are indicated by a dashed line;

FIG. 1b is a detailed view of the joint between the two timber panels in FIG. 1a, with the recess hidden beneath the usable surface again indicated by a dashed line;

FIG. 1c is an A-A cross-sectional view of the version of the composite timber panel shown in FIG. 1a;

FIG. 1d is a schematic view of the first lateral side of the first timber construction panel with two recesses, and

FIG. 1e shows the adhesive-filled recesses of the first lateral side of the first timber construction panel shown in FIG. 1d.

FIG. 2a is an embodiment example in which the recesses are arranged along the lateral longitudinal side, which in this embodiment is the first lateral side, and

FIG. 2b is a perspective view of the embodiment shown in FIGS. 1a to 1e, in which the recesses are arranged along the lateral broad side, which in this embodiment is the first lateral side.

FIGS. 3a to 3e, as well as 4a and 4b are illustrations of possible embodiments of a composite timber construction panel in which the lower usable surfaces of the two bonded panels are flush with each other, while there is a gap between the upper usable surfaces caused by the recess.

FIG. 3a is a top view of the assembled timber construction panel, the two recesses filled with adhesive are open at the top so that the adhesive is visible;

FIG. 3b is a detailed view of the joint between the two timber panels in FIG. 3a, where the gap formed by the recess can be seen;

FIG. 3c is an A-A cross-sectional view of the version of the composite timber panel shown in FIG. 3a;

FIG. 3d is a schematic view of the first lateral side of the first timber construction panel with two recesses, and

FIG. 3e shows the adhesive-filled recesses of the first lateral side of the first timber construction panel shown in FIG. 3d.

FIG. 4a is an embodiment example in which the recesses are arranged along the lateral longitudinal side, which in this embodiment is the first lateral side, and

FIG. 4b is a perspective view of the embodiment shown in FIGS. 3a to 3e, in which the recesses are arranged along the lateral broad side, which in this embodiment is the first lateral side.

FIG. 5 is a partial view of a cross-section through a composite plate at the level of a transverse filling opening of the embodiment shown in FIGS. 1a to 1e.

FIG. 6 is a flow chart in which individual process steps of a preferred embodiment of the present invention are shown.

### EMBODIMENTS OF THE INVENTION

Embodiments of the invention are illustrated by means of the Figures.

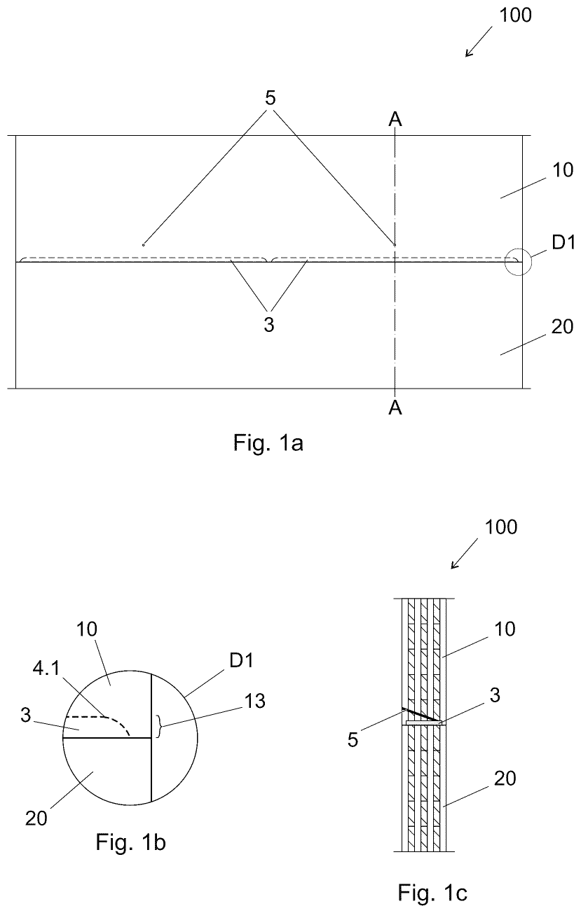

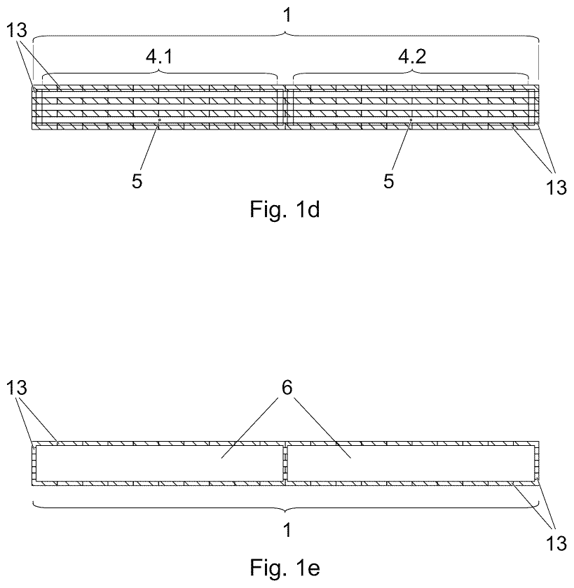

The timber construction panels shown in the Figures are biaxial load-bearing panels made of timber-based material. The panels shown in FIGS. 1c, 1d, 1e, 3c and 5 are cross-laminated timber panels, whereby the end faces of the alternating layers are shown with diagonal stripes and the faces of the alternating layers aligned parallel to the main grain direction are shown in white.

FIGS. 1a to 1e schematically illustrate a first embodiment example of an assembled timber component 100 bonded in accordance with the present invention. Two timber construction panels 10, 20 are joined together via two cavities 3 filled with adhesive 6, which is formed between the connecting sides of the two timber construction panels.

In order to create these cavities, the first timber construction panel 10 may be provided with two recesses 4.1, 4.2 on a first lateral side 1, as shown in FIG. 1e.

The recesses 4.1, 4.2 are laterally delimited by non-recessed portions 13 of the first lateral side 1. These portions 13 can surround the recess over its entire circumference. In other words, the portions 13 of the first lateral side of the first timber construction panel may comprise all sidewalls of a cavity 3 defined by a recess.

In order to fill the cavity or cavities with adhesive, transverse filling openings 5 are preferably provided, which extend from the upper useable surface 8 of the first construction panel into a respective recess 4.1, 4.2 of the first lateral side 1.

Preferably, the filling openings 5 open in a lower area, preferably in the lower quarter, of a cavity 3, as shown in FIG. 1c. This arrangement ensures that the cavity is filled from bottom to top, which prevents air bubbles from being trapped.

Filling the cavity 3 from above is less suitable, as this very easily traps air bubbles in the adhesive layer.

The one or more recesses may for example be milled into the first lateral side of the first timber construction panel. Preferably, the recesses are produced in an automated, industrial process.

There is no specific limit to the number of recesses or the number of cavities defined by the recesses. The number of cavities can increase as the length of the first lateral side increases.

However, the cavities 3 must extend over a section of the first side and be suitable for filling with a two-component adhesive.

In order to prevent the two-component adhesive from leaking out of the at least one cavity 3, the surfaces of the first and second timber construction panel surrounding the cavity and adjoining each other must be sealed to the outside on at least three sides, i.e. on the bottom and the lateral sides.

Furthermore, the recesses 4.1, 4.2, 4.n should have a minimum depth to enable the formation of an adhesive layer with a thickness of at least 1 mm, at least 2 mm, at least 3 mm, at least 4 mm or at least 5 mm.

The distance created by the recess between the two bonded surfaces of the timber construction panels should not be less than the minimum distance, as this would impair the stability of the bond. In order to enable force transmission between the two timber construction panels, the two panels must be bonded over a minimum distance.

The minimum distance ensures that a two-component adhesive layer can be formed that has a sufficient layer thickness to be able to fully transfer the forces introduced into one timber panel to the other timber panel. As a result, the load force to which one of the panels is subjected is distributed homogeneously over the entire surface of the assembled timber panel. There is therefore no abrupt difference in load force between the two timber panels. As an abrupt difference in the load force applied at the joint between the two panels is thus avoided, the joint is more stable due to the minimum distance between the bonded surfaces.

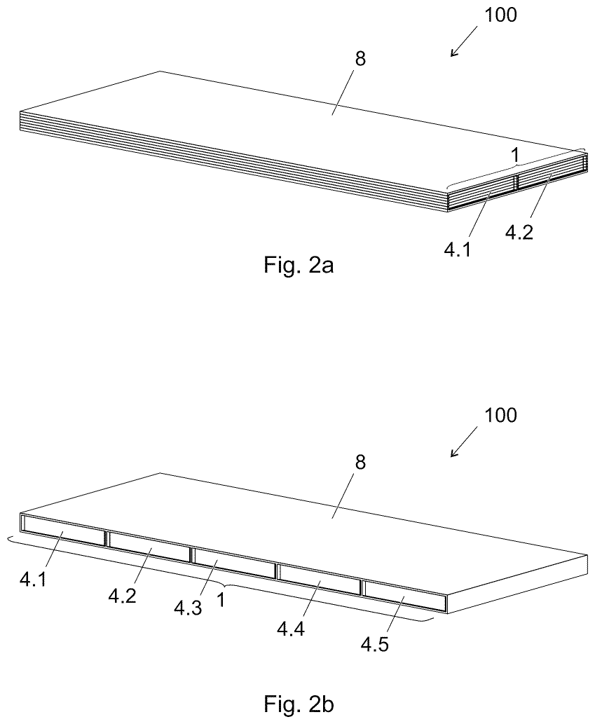

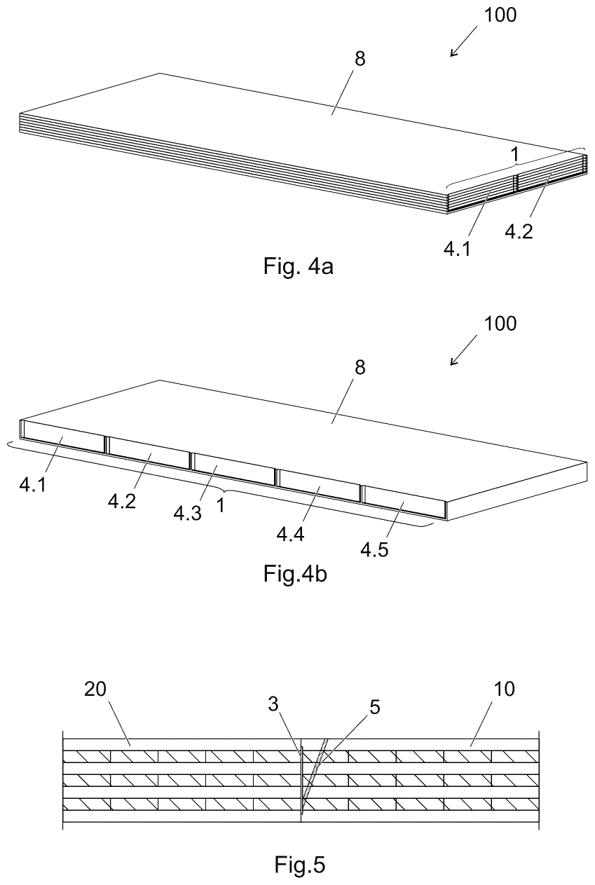

The one or more recesses 4.1, 4.2, 4.n are arranged in the first lateral side 1 of the first timber construction panel 10. The first lateral side may be a broad side, as shown in FIGS. 2a and 4a, or a long side, as shown in FIGS. 2b and 4b. The recesses 4.1, 4.2, 4.3, 4.4, 4.5 may accordingly be formed in a long side of the first timber construction panel. The recesses 4.1, 4.2 may also be formed in a broad side of the first timber construction panel.

Preferably, a timber construction panel is enlarged by attaching a second timber construction panel along only one dimension, in other words, the timber construction panel is either lengthened or widened by bonding it to a second timber construction panel according to the present invention.

However, it is also possible for a timber construction panel to be enlarged in two dimensions. For this purpose, for example, a third timber construction panel may be bonded to a second lateral side of the first or the second timber construction panel, which is not parallel to the first side, over one or more cavities. The cavity or cavities are defined by one or more recesses formed in at least one of the lateral sides bonded together

In order to join the two panels together, the first lateral side 1 of the first timber construction panel 10 is arranged against a corresponding first lateral side of a second timber construction panel 20. In the embodiments shown, the first lateral side of the second timber construction panel 20 is a flat side without recesses.

However, it is also possible that the first lateral side of the second timber construction panel 20 is also provided with a recesses. In this embodiment, the recesses of the two panels must be designed and arranged in such a way in the assembled timber construction panel that in each case one recess of the first timber construction panel and one recess of the second timber construction panel together form a cavity 3.

A possible embodiment of a composite timber construction panel 100, in which the lateral sides of the at least one cavity 3 are completely surrounded on the outside by portions 13 of the first timber construction panel, is shown schematically in FIGS. 1a to 1e and FIGS. 2a and 2b. In these Figures, all side walls of a cavity are formed by the delimiting portions 13 of the first timber construction panel 10. Such a cavity is referred to here as a closed cavity.

This design has the advantage that the cavity or cavities 3 of the assembled timber construction panel 100 are completely concealed. With the exception of a filling opening 5 for filling the closed cavity with adhesive and a vent opening (not shown), the adhesive layer filled in the cavity is inaccessible from the outside and thus protected against environmental influences.

The recesses 4,. 1, 4.2, which define the closed cavities 3, are indicated as dashed lines in FIGS. 1a and 1b, which is a detailed view D1 of the representation in FIG. 1a. However, the recesses and closed cavities in a composite timber construction panel of this embodiment example are not visible from the outside.

In a preferred embodiment, the upper usable surfaces 8 and the lower usable surfaces of the two timber panels 10, 20 are flush with one another.

Views of the first lateral side 1 of the embodiment example in FIGS. 1a to 1c are shown in FIGS. 1d and 1e, where FIG. 1d shows the two recesses 4.1, 4.2 without adhesive, and FIG. 1e shows the recesses filled with adhesive 6.

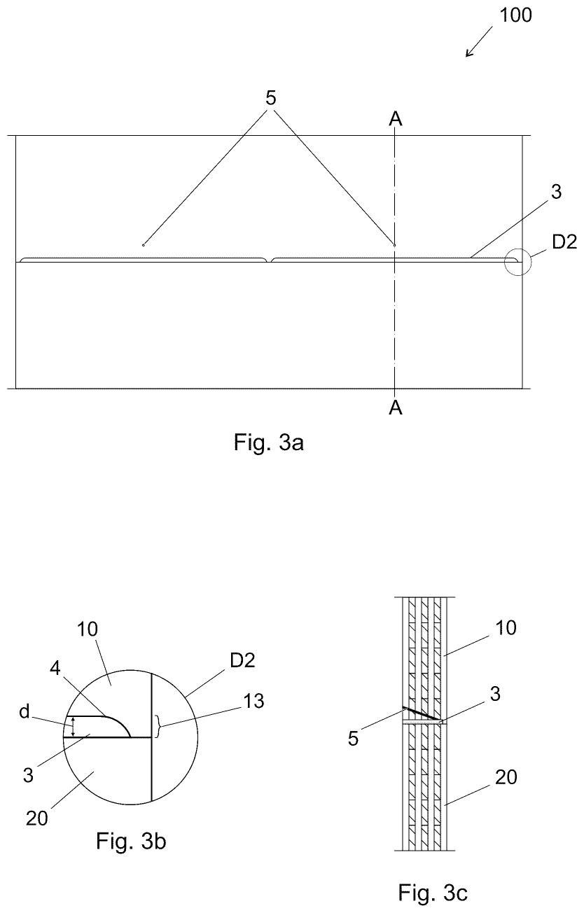

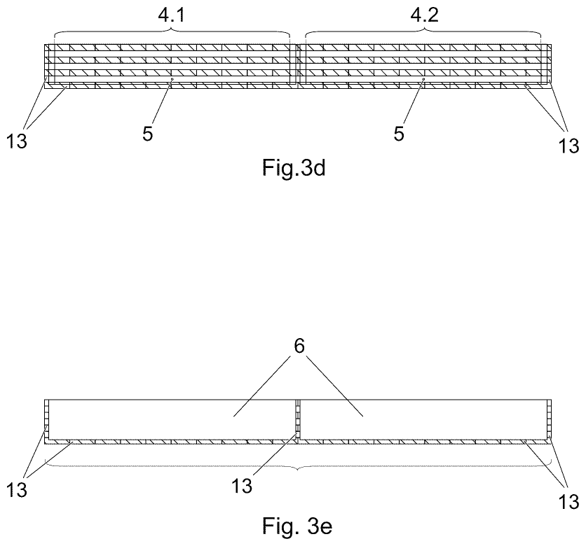

FIGS. 3a to 3e and FIGS. 4a and 4b relate to embodiments in which the delimiting portions 13 of the first side of the first timber panel surround the recesses 4.1, 4.2, 4.n on three sides. A cavity defined by such a recess between two adjacent timber panels is hereinafter referred to as an open cavity.

The limiting portions 13 form the lower wall to the lower usable surface, as well as the two lateral walls of the shallow recess. However, the recess is not limited against the edge of the upper usable surface. This means that an open cavity 3 defined by a recess is open at the top. In this embodiment, there is an open joint with a distance d between the upper usable surfaces 8 of the two bonded timber panels 10, 20, as shown in FIG. 3a and the detailed view D2 in FIG. 3b.

Views of the first lateral side 1 of the embodiment example in FIGS. 3a to 3c are shown in FIGS. 3d and 3e, where FIG. 3d shows the two recesses 4.1, 4.2 without adhesive, and FIG. 3e shows the recesses filled with adhesive 6.

FIGS. 4a and 4b each show first timber panels in which the recesses 4.1, 4.2 are formed in a first lateral broad side 1 (FIG. 4a), or in one in which the recesses 4.1, 4.2, 4.3, 4.4, 4.5 are formed in a first lateral long side 1 (FIG. 4b).

FIG. 5 is a detailed view of a cross-section of a composite timber construction panel at the level of a transverse filling opening 5, which opens into a closed cavity 3. The filling opening extends from the upper usable surface 8 of the first timber panel into the lower area, preferably the lower quarter, of the cavity 3.

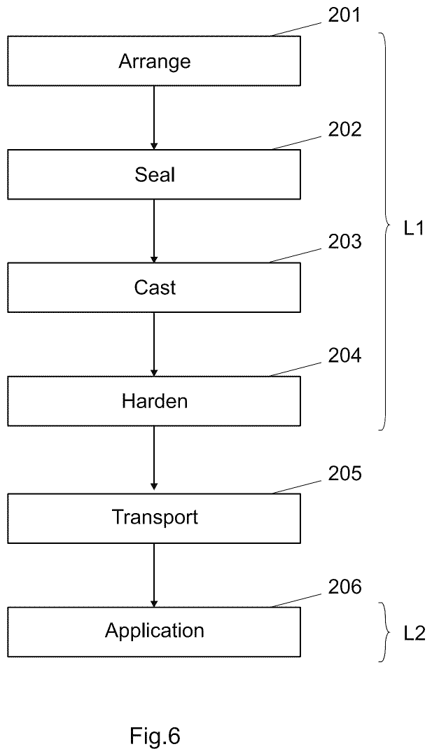

FIG. 6 shows individual process steps of a preferred embodiment of the invention in a schematic flow chart.

The process steps 201 to 204 are preferably carried out at a first location L1. This first location L1 is preferably an industrial plant, for example a production facility for timber construction panels.

A first and a second timber construction panel are aligned with respect to one another in such a way that their respective first lateral sides to be bonded 201 adjoin one another. At least the first timber construction panel 10 has, as described herein, one or more planar recesses 4,1, 4.2, 4.n, so that only the surface-delimiting portions 13 of the first lateral side of the first timber construction panel 10 adjoin the surface of the first lateral side of the second timber construction panel 20. The recesses are aligned to form a cavity 3 together with the adjacent first side of the second timber construction panel 20.

Adjacent surfaces of the first lateral sides are sealed 202. At least the connecting surfaces of those portions of the first lateral sides that laterally delimit the cavity or cavities 3 of the composite timber construction panel lying on its lower usable surface towards the outside and downwards are sealed. The cavity or cavities are thus sealed on at least three sides 202.

To provide a seal 202 a suitable sealing material may for example be applied to the portion (13) of the first timber construction panel that delimits at least one recess. The connecting surface of the delimiting portion treated with sealing material is then attached to the first side of the second timber construction panel so that it abuts the latter tightly. This may be done before the two timber construction panels are arranged in relation to each other.

However, sealing 202 can also be perforemd after the two timber construction panels have been arranged and before the at least one cavity has been filled with adhesive.

The seal must be suitable for preventing leakage of a two-component adhesive between the adjoining portions of the first and second timber construction panel. A suitable adhesive or another sealing material, such as silicone, may be used for this purpose. An adhesive as a sealing material has the additional advantage of reducing the risk that the two timber panels slip to change their position with respect to one another.

A suitable adhesive for sealing may for example be a one-component adhesive or a two-component adhesive. To form the sealing bond, the connecting surfaces of the first and the second timber construction panel preferably abut each other tightly. Optionally, the sealing bond may be a press bond.

In a next step 203, the cavity or cavities 3 between the first lateral sides of the two timber construction panels are completely filled with a two-component adhesive. Pouring 203 of a cavity 3 is preferably carried out through a filling opening 5 opening into a lower region of the cavity.

The casting 203 of the two timber construction panels may be accelerated by arranging several cavities next to each other in the first lateral side of the first timber construction panel, as this arrangement allows the individual cavities to be filled simultaneously.

Optionally, the method may also comprise a first step of forming one or more recesses 4.1, 4.2, 4.n in the first lateral side 1 of the first timber construction panel 10. As mentioned, the recesses are formed in such a way that they extend over a partial area of a first lateral side 1 and that they are laterally at least partially delimited by portions 13 of the first timber construction panel 10. This step may also be automated.

Preferably, this optional initial process step is carried out at the first location L1. However, the first timber construction panels may also be provided with the recesses at another location. The first timber construction panels with recesses may then be delivered to the first location L1.

Some of the process steps, in particular step 202 and/or 203, or process steps 201 to 203 may be automated in an industrial production plant. The step of forming the recesses may also be carried out automatically in the same industrial production plant.

No additional intervention is required for curing the adhesive 204, the assembled timber construction panels merely rest for a certain minimum time, which depends on the type of two-component adhesive and its temperature. As mentioned above, it is advantageous if the adhesive layer hardens without exerting a compression pressure, as this contributes to the improved stability of the joint.

In a further, optional step, the assembled timber construction panel is transported from the first location L1 to a second location L2. The transportation 205 of the timber construction panel is carried out using a conventional means of goods transportation, for example trucks conventionally used in the construction industry. Conventional articulated vehicles typically have a maximum overall length of 16.5 m, with the length of the trailer being approximately 13.6 m.

The second location L2 is the destination location at which the composite timber construction panel is used 206. This location L2 be a construction site or an existing building may for example.

The timber construction panel may be further processed at the second location 2. For example, several assembled timber construction panels 100 may be glued together at the second location L2 to form a storey ceiling.

1. A method of making a composite timber construction panel for building structures, comprising the steps of
(i) Arranging a first timber construction panel with respect to a second timber construction panel, said first timber construction panel comprising one or more recesses in a first lateral side, said recesses having a flat floor extending over a portion of the area of the first lateral side, wherein the floors of the one or more recesses together occupy at least 50% of the first lateral side of the first timber construction panel, and wherein the recesses are laterally at least partially delimited by portions of the first timber construction panel, such that one or more of the delimiting portions of the one or more recesses of the first timber construction panel adjoin a first lateral side of the second timber construction panel,
(ii) Filling of the one or more recesses with a two-component adhesive,
(iii) Curing of the two-component adhesive.

2. The method according to claim 1, comprising the following additional step which is carried out before the step (i) of arranging the first timber construction panel:
Forming of one or more recesses in the first lateral side of the first timber construction panel, such that the one or more recesses extend over a partial area of a first lateral side, and such that the one or more recesses are laterally at least partially delimited by portions of the first timber construction panel.

3. The method according to claim 1, comprising an additional step of
Applying of a sealing compound, for example an adhesive or silicone, to the connecting surfaces of the delimiting portions of the first timber construction panel, prior to step (i) of arranging the two timber construction panels,
and/or the
sealing Sealing of connecting surfaces of the first timber construction panel and the second timber construction panel before step (ii) of filling.

4. The method according to claim 1, wherein connecting surfaces of the first timber construction panel and the second timber construction panel are arranged in step (i) in such a way that they are fixed in respect to each other.

5. The method according to claim 1, wherein the first and second timber construction panels are biaxial load-bearing timber components.

6. The method according to claim 1, which is an at least partially automated method in which at least the step (ii) of filling the one or more recesses is performed mechanically.

7. The method according to claim 1, wherein the flat floor(s) of the one or more recesses together occupy at least 60%, at least 70%, at least 80%, at least 90%, at least 95%, or at least 98% of the first lateral side (1) of the first timber construction panel.

8. The method according to claim 1, wherein the one or more recesses have a minimum depth of 1 mm, 2 mm, 3 mm, 4 mm or 5 mm.

9. The method according to claim 1, wherein the first lateral surface of the second timber construction panel comprises either a uniformly flat surface, or a flat surface with one or more recesses.

10. The method according to claim 1, wherein the first timber construction panel and the second timber construction panel are arranged such that the at least one cavity formed by a recess between the first timber construction panel and the second timber construction panel is fully surrounded by delimiting portions of the first and, optionally, by delimiting portions of the second timber construction panel.

11. The method according to claim 1, wherein the cavities formed by the one or more recesses between the first and the second timber construction panels are cast by pouring the two-component adhesive into a filling opening which is arranged in one of the two timber construction panels and which opens into the cavity.

12. The method according to claim 1, wherein the first timber construction panel and the second timber construction panel each have two lateral long sides and two shorter lateral broad sides, and wherein the two timber construction panels are each connected to one another via a lateral long side of the first timber construction panel and a lateral long side of the second timber construction panel, or via a lateral broad side of the first timber construction panel and a lateral broad side of the second timber construction panel.

13. The method according to claim 1, wherein the curing (iii), of the two-component adhesive takes place without compression.

14. The method according to claim 1, wherein the method is carried out at a first location L1, for example in a production facility, and wherein the first location L1 is a different location than the location L2, for example a construction site or in an existing building, where the composite timber construction panel is used.

15. A composite timber construction panel for building structures, comprising
(iv) a first timber construction panel comprising one or more recesses in a first lateral side with a flat floor extending over a partial area of the first lateral side, wherein the floors of the one or more recesses together occupy at least 50% of the first lateral side of the first timber construction panel, and wherein the recesses are laterally at least partially delimited by portions of the first timber construction panel
(v) a second timber construction panel having a first lateral side which adjoins the first lateral side of the first timber construction panel the first and second timber construction panels together forming one or more cavities each formed by one of the recesses,
(vi) wherein the distance between the floor of the at least one recess of the first timber construction panel delimiting a cavity and the side of the second timber construction panel delimiting the cavity is at least 1 mm, at least 2 mm, at least 3 mm, at least 4 mm or at least 5 mm,
(vii) wherein the at least one cavity is completely filled with a two-component adhesive, and
(viii) wherein at least one of the two usable surfaces of the first timber construction panel adjoins a corresponding usable surface of the second timber construction panel.

16. The composite timber construction panel according to claim 15, wherein the composite timber construction panel is a biaxial load-bearing timber component suitable for forming at least part of a storey ceiling.
